(19) United States
(12) Patent Application Publication
(10) Pub. No.: US 2018/0229428 A1
(43) Pub. Date: Aug. 16, 2018

(54) THREE-DIMENSIONAL PRINTING DEVICE

(71) Applicant: Roland DG Corporation, Hamamatsu-shi (JP)

(72) Inventor: Takafumi TAKANO, Hamamatsu-shi (JP)

(21) Appl. No.: 15/891,402

(22) Filed: Feb. 8, 2018

(30) Foreign Application Priority Data
Feb. 10, 2017 (JP) 2017-023176

(51) Int. Cl. B29C 64/165; B29C 64/255; B29C 64/295; B29C 64/218; B22F 1/00; B29C 64/393; B29C 64/209

(52) U.S. Cl. CPC B29C 64/165; B29C 64/255; B29C 64/295; B33Y 30/00; B22F 1/0059; B29C 64/393; B29C 64/209; B29C 64/218

(57) ABSTRACT

A three-dimensional printing device includes a reservoir that stores a powdery material, a powder heater provided in the reservoir and capable of heating the powdery material, a printing table that allows the powdery material to be put thereon, an injection head that injects a curing liquid binding the powdery material, and a conveyor that moves the printing table and the injection head with respect to each other.

### CROSS REFERENCE TO RELATED APPLICATIONS

This application claims the benefit of priority to Japanese Patent Application No. 2017-023176 filed on Feb. 10, 2017. The entire contents of this application are hereby incorporated herein by reference.

### BACKGROUND OF THE INVENTION

### 1. Field of the Invention

The present invention relates to a three-dimensional printing device capable of performing three-dimensional printing (also referred to as “additive manufacturing”) by use of a powdery material.

### 2. Description of the Related Art

Conventionally, a powder lamination method for forming a three-dimensional printed item is known. According to the powder lamination method, particles of a powdery material are bound by a binder to form layers having a predetermined cross-sectional shape, and the layers are sequentially and integrally laminated to form a three-dimensional printed item. An example of a generally used three-dimensional printing device used for the powder lamination method includes a reservoir that stores the powdery material, a printing tank that accommodates the powdery material to perform printing, and an injection head that injects the binder toward the powdery material accommodated in the printing tank.

In such a three-dimensional printing device for the powder lamination method, a binder liquid is supplied in a predetermined shape to the powdery material provided in a thin layer in the printing tank, so that the layers of the powdery material are formed one by one to have an intended shape. In order to improve the printing precision and the quality of the printed item, it is important that the powdery material is supplied to the printing tank in a flat and homogeneous state. For this purpose, as disclosed in Japanese Patent No. 5400042 and Japanese Laid-Open Patent Publication No. 2015-223768, the three-dimensional printing device includes a powder transfer conveyor that supplies the powdery material from the reservoir to the printing tank and flattens a surface of the powdery material. A highly fluid powdery material is preferably used. Nonetheless, a three-dimensional printing device capable of printing at higher precision is desired.

### SUMMARY OF THE INVENTION

Preferred embodiments of the present invention provide three-dimensional printing devices capable of forming a three-dimensional printed item having a higher level of precision by a powder lamination method.

As a result of performing active studies, the present inventor made the following discoveries and invented the preferred embodiments of the present invention. In general, a powdery material has moisture-absorption characteristics. A powdery material that has absorbed a relatively large amount of moisture in the atmosphere tends to be inferior in the fluidity and, based on the inferior fluidity, also tends to be inferior in the precision of printing performed by a powder lamination method.

A three-dimensional printing device according to a preferred embodiment of the present invention includes a reservoir that stores a powdery material; a powder heater provided in the reservoir, the powder heater heating the powdery material; a printing table that allows the powdery material to be put thereon; an injection head that injects a curing liquid binding the powdery material; and a conveyor that moves the printing table and the injection head with respect to each other.

According to the three-dimensional printing device having the above-described structure, the powdery material may be heated before being supplied to the printing table. Therefore, in the case where the powdery material contains moisture in the atmosphere, the moisture contained in the powdery material may be removed to dry the powdery material. This improves the fluidity of the powdery material, and thus the powdery material may be supplied in a flat and homogeneous thin layer on the printing table. Since the powdery material is dry, the curing liquid injected toward the powdery material layer is absorbed into the powdery material layer in a preferred manner. As a result, a three-dimensional printed item cured uniformly is formed. In this step, the curing liquid is prevented from leaking from a region to which the curing liquid has been supplied into an unintended region, or from being locally stored in a gap or the like in the powdery material layer. Japanese Patent No. 5400042 and Japanese Laid-Open Patent Publication No. 2015-223768 each disclose a three-dimensional printing device capable of heating a powdery material supplied to the printing tank. However, such a device is provided to promote the drying of the binder liquid, and is clearly distinguished from the technology disclosed herein in the structure and the function/effect by a powder lamination method.

Preferred embodiments of the present invention provide three-dimensional printing devices capable of forming a three-dimensional printed item having a higher level of precision by a powder lamination method.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of a three-dimensional printing device according to a preferred embodiment of the present invention.

FIG. 2 is a plan view of the three-dimensional printing device shown in FIG. 1.

FIG. 3 is a schematic cross-sectional view of a reservoir according to a preferred embodiment of the present invention.

FIG. 4 is a block diagram of a controller according to a preferred embodiment of the present invention.

FIG. 5 is a schematic cross-sectional view of a three-dimensional printing device according to another preferred embodiment of the present invention.

FIG. 6 is a scanning electron micrograph of gypsum powder for three-dimensional printing used in an example.

### DETAILED DESCRIPTION OF THE PREFERRED EMBODIMENTS

Hereinafter, preferred embodiments of the present invention will be described with reference to the drawings. The preferred embodiments described below are not intended to specifically limit the present invention. Components and portions that have the same functions will bear the same reference signs, and overlapping descriptions will be omitted or simplified optionally.

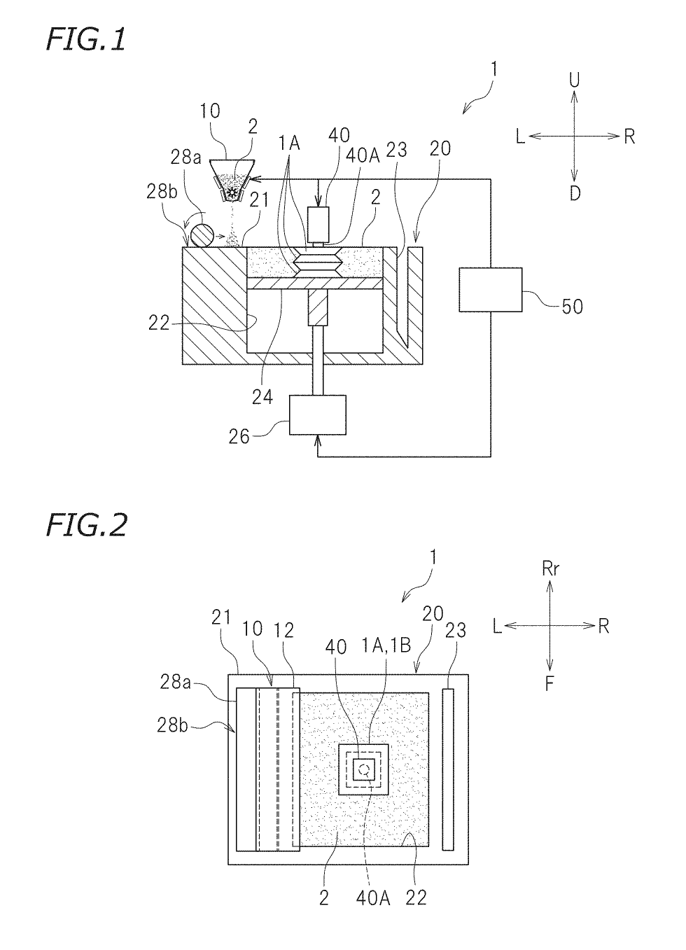

FIG. 1 is a cross-sectional view of a three-dimensional printing device 1 according to a preferred embodiment of the present invention. FIG. 2 is a plan view of the three-dimensional printing device 1 shown in FIG. 1. In the drawings, letters F, Rr, L, R, U and D respectively represent “front”, “rear”, “left”, “right”, “up” and “down”. These directions are provided merely for the sake of convenience, and do not limit the manner of installation or the like of the three-dimensional printing device 1.

The three-dimensional printing device 1 is a device that binds particles of a powdery material 2 into a layer having a predetermined cross-sectional shape to form a powder-solidified layer 1A and integrally laminates such powder-solidified layers 1A one by one to form a target three-dimensional printed item 1B. The three-dimensional printing device 1 in this preferred embodiment includes a reservoir 10, a printer 20, an injection head 40, and a controller 50. Hereinafter, a structure and a general operation of each of the components of the three-dimensional printing device 1 will be described.

The printer 20 includes a printing tank 22, a powder recovery portion 23, a printing table 24, a table elevator 26, and a powder transfer conveyor 28. The printer 20 includes a flat top surface 21. The printing tank 22 and the powder recovery portion 23 are provided side by side and independently from each other, and are recessed from the top surface 21. Inside the printing tank 22, the printing table 24 having a shape corresponding to a shape of a bottom surface of the printing tank 22 is accommodated. The printing table 24 has no space from an inner side wall of the printing tank 22. An area enclosed by the printing tank 22 and a top surface of the printing table 24 is a printing area. In the printing area, the powdery material 2 is accommodated, and the three-dimensional printed item 1B is formed. A bottom surface of the printing table 24 is supported by the table elevator 26. The printing table 24 is movable in an up-down direction in the printing tank 22. The table elevator 26 is capable of moving the printing table 24 in the up-down direction. There is no specific limitation on the table elevator 26. In this example, the table elevator 26 is a cylinder mechanism. The table elevator 26 is a conveyor that moves the printing table 24 and the injection head 40 with respect to each other. The powder recovery portion 23 includes a space that accommodates and recovers a portion of the powder material 2 that is excessively supplied to the printer 20. The powder recovery portion 23 includes an outlet (not shown), in a bottom portion thereof, through which the recovered powder material 2 is removed.

The powder transfer conveyor 28 is provided on the top surface 21 of the printer 20. The powder transfer conveyor 28 includes a cylindrical squeegee roller 28a and a motor (not shown). The squeegee roller 28a has a lengthy cylindrical shape and is located such that an axis of the cylinder is oriented in a front-rear direction of the three-dimensional printing device 1 and such that the squeegee roller 28a is suspended above the printing tank 22 while extending in the front-rear direction. The motor is capable of rotating the squeegee roller 28a forward or backward. The motor is also capable of moving the squeegee roller 28a leftward and rightward on the top surface 21 of the printer 20 (i.e., on a top end of the printing tank 22). The powder transfer conveyor 28 is configured such that, for example, the squeegee roller 28a is driven by the motor to rotate backward (counterclockwise in FIG. 1) while moving rightward to pass above the printing tank 22 and to reach the powder recovery portion 23. The powder transfer conveyor 28 is also configured such that, for example, the squeegee roller 28a is driven by the motor to move, without being rotated, leftward to a roller waiting portion 28b. When not in use, the squeegee roller 28a is located at the roller waiting portion 28b, which is provided at a left end of the printer 20.

There is no specific limitation on the composition, form or the like of the powdery material 2, which is a main component of the three-dimensional printed item 1B. The powdery material 2 may contain powder selected from various materials including resin materials, metal materials, inorganic materials and the like. In this preferred embodiment, the powdery material 2 is supplied by free fall from the reservoir 10 to the printer 20. Therefore, it is preferred that the powdery material 2 contains at least one of a metal material and an inorganic material having a relatively high specific gravity. There is no specific limitation on the inorganic material usable for the powdery material 2. Examples of the inorganic material usable for the powdery material 2 include gypsum, silica, alumina, zirconia, apatite and the like. Gypsum may be, for example, either gypsum hemihydrate (α-type calcined gypsum, β-type calcined gypsum) or gypsum dehydrate. Examples of the metal material usable for the powdery material 2 include iron, aluminum, titanium, alloys thereof (typically, stainless steel, alloys of titanium, alloys of aluminum) and the like. These materials may be used independently or as a combination of two or more.

The powdery material 2 may be formed of powder of any of the above-described materials, or may contain the powder of any of the above-described materials as a main component and also contain, as a sub material, an infiltrant that promotes permeation of a curing liquid described below. The infiltrant cooperates with the curing liquid described below to bind (cure) the main material. In the case where the powdery material 2 contains the infiltrant in advance, the three-dimensional printed item 1B is formed to be strong and to have a high level of printing precision when the curing liquid is supplied. As described below, the curing liquid may be, for example, water, wax, binder or the like. The infiltrant may be, for example, water infiltrant, wax infiltrant, binder infiltrant or the like. The infiltrant may be typically a water-soluble resin. The water-soluble resin is a polymer compound that is water-soluble and is bindable when containing water. There is no specific limitation on the water-soluble resin. The water-soluble resin may be, for example, starch, polyvinyl alcohol (PVA), polyvinylpyrrolidone (PVP), water-soluble acrylic resin, water-soluble urethane resin, water-soluble polyamide resin and the like. A preferably usable water-soluble resin has a glass transition temperature of about 100° C. or lower, typically about 80° C. or lower, preferably about 70° C. or lower, for example, about 60° C. or lower, and typically about 25° C. or higher, preferably about 35° C. or higher, for example, about 40° C. or higher. Among such water-soluble resins, PVA may be suitably used because PVA is easily soluble in water, is easily controllable in terms of the glass transition temperature in a low temperature range, and does not leave much sintering residues. In the powder material 2, the ratio between the main material (e.g., metal material and/or inorganic material) and the sub material (water-soluble resin) may be, for example, from about 30:70 to about 70:30 by volume (e.g., about 50:50) and from about 95:5 to about 80:20 (e.g., about 9:1) by mass. There is no specific limitation on the presence form of the main material and the sub material. For example, a surface of particles of the main material may be coated with a layer of the sub material; particles of the main material and particles of the sub material may be mixed to form a mixed powdery material; or microscopic particles of the sub material may be bound to a surface of particles of the main material. Preferably, the main material and the sub material may be present in the mixed powdery material, which may be prepared without burden on the sub material. With a metal material or an inorganic material, it may be more difficult, or may be more costly, to form a powdery material formed of particles having a shape close to a truly spherical shape, than with a resin material. With a metal material or an inorganic material, the curing liquid (described below), when being supplied, tends not to be wet-spread between the particle. For these reasons, in the case where powder that may contain particles having a shape quite different from a truly spherical shape, for example, powder formed of a metal material and/or an inorganic material, is used as the powdery material 2 for three-dimensional printing, it is preferred that the powdery material 2 also contains, in advance, a water-soluble resin or the like that contributes to binding of the particles.

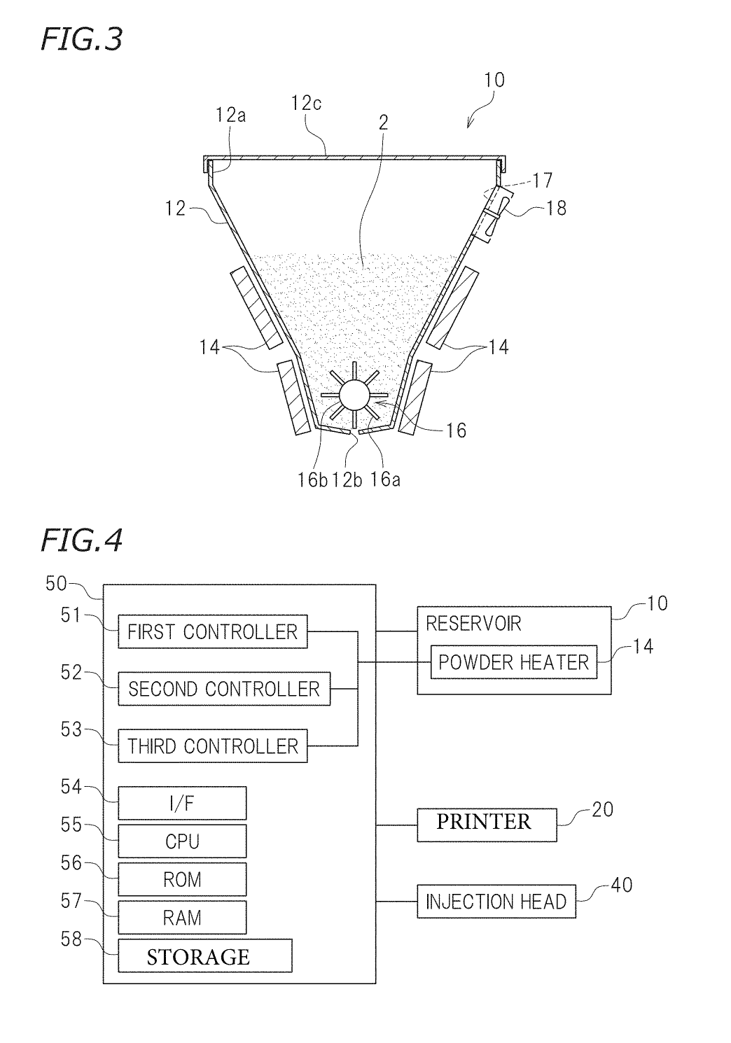

FIG. 3 is a cross-sectional view showing a structure of the reservoir 10. In the reservoir 10, the above-described powdery material 2 is stored. In this preferred embodiment, the reservoir 10 is provided at a higher level than the printer 20. The reservoir preferably has a lengthy rectangular or substantially rectangular shape as seen in a plan view (see FIG. 2), and a size thereof in a longitudinal direction matches or substantially matches a size of the printing tank 22 in the front-rear direction. The reservoir 10 includes a reservoir tank 12. A planar area size of the reservoir tank 12 decreases toward a bottom end thereof. The reservoir tank 12 preferably has a generally inverted-triangular cross-sectional shape. The reservoir tank 12 is provided with an opening 12 at a top end thereof and a slit-shaped supply portion 12b at the bottom end thereof. The slit-shaped supply portion 12b is an example of a supply opening. The reservoir tank 12 is located at a position that is above the printer 20 and is to the left of the printing tank 22, not just above the printing tank 22, such that the longitudinal direction of the reservoir tank 12 is the front-rear direction of the three-dimensional printing device 1. The powdery material 2, after being introduced to the reservoir tank 12 through the opening 12a, is fed along a wall of the reservoir tank 12 toward the supply portion 12b at the bottom end by the weight of the powdery material 2. The powdery material 2 is discharged from the reservoir 10 through the supply portion 12b. The powdery material 2, after being discharged from the reservoir 10, falls and is supplied to the top surface 21 of the printer 20. The powdery material 2 is supplied in a linear shape to an area between the roller waiting portion 28b and the printing tank 22. The reservoir 10 may include a shutter member (not shown) that may be slid to close the supply portion 12b. This prevents the powdery material 2 from being discharged from the supply portion 12b at an unintended timing. The reservoir 10 includes a lid 12c covering the opening 12a of the reservoir tank 12. The lid 12c may cover the opening 12a to prevent the inside of the reservoir tank 12 from being contaminated with foreign objects.

The reservoir tank 12 is provided with powder heaters 14 that heat the powdery material 2 stored in the reservoir tank 12. There is no specific limitation on the structure of each of the powder heaters 14. For example, the powder heaters 14 may each be any of various heating devices including heating mechanisms of the following types: convective heat transfer of introducing a heated fluid (typically, air) to the powdery material 2; radiation heat transfer of irradiating the powdery material 2 with infrared light; internal heat generation of irradiating the powdery material 2 with microwave; electric heat transfer of putting a resistance material into contact with the powdery material 2; and the like. The powder heaters 14 of such a type may heat the powdery material in the reservoir 10 to dry the powdery material 2 at normal pressure (typically, 1 atm). In this preferred embodiment, the powder heaters 14 preferably are each an electric heat transfer heating device including a resistance heating plate and a thermostat (not shown). The powder heaters 14 may, for example, set the heating temperature to a predetermined level that is lower than, or equal to, the glass transition temperature of a water-soluble resin contained in the powdery material 2. In this preferred embodiment, the powder heaters 14 are provided at a position that is outside of a bottom portion of the reservoir tank 12 and in the vicinity of the supply portion 12b.

The reservoir tank 12 accommodates a powder stirrer 16 that stirs the powder material 12 in the bottom portion thereof. The powder stirrer 16 is a rotatable lateral stirrer that includes a rotation shaft 16b extending in the longitudinal direction of the reservoir tank 12 and also includes a plurality of stirring blades 16a attached to the rotation shaft 16b. There is no specific limitation on the shape of the stirring blades 16a. The stirring blades 16a may be, for example, paddle-shaped, anchor-shaped, turbine-shaped, spiral, spool-shaped or the like. The powder stirrer 16 is connected to a motor (not shown). The rotation shaft 16b is rotated by the motor, and as a result, the stirring blades 16a are pivoted to stir the powder material 2. This improves the fluidity of the powder material 2, and promotes the supply of the powder material 2 to the supply portion 12b and discharge of the powder material 2 from the supply portion 12b. A filter 17 and a fan 18 are provided at a position outer to a top portion of the reservoir tank 12. The fan 18 replaces gas inside reservoir tank 12 with gas outside the reservoir tank 12. The filter 17 is provided to insulate the inside of the reservoir tank 12 from the fan 18, and allows the gas to pass the filter 17 but catches the powder material 2. When, for example, the fan 18 is actuated, the filter 17 prevents the powder material 2 from being discharged outside together with the gas.

The injection head 40 (FIG. 1) is provided above the printer 20. The injection head 40 supplies the curing liquid that cures the powder material 2. The injection head 40 includes a nozzle 40A through which the curing liquid is injected. The nozzle 40A is connected with an accommodation tank (not shown) for the curing liquid. The injection head 40 is an inkjet-system supply head that is connected with a driving device (not shown) and injects the curing liquid through the nozzle 40A. The injection head 40 is also connected with a moving device (not shown), and is movable in the front-rear direction and the left-right direction in a horizontal plane with respect to the printing tank 22. The driving device and the moving device for the injection head 40 are connected to the controller 50 described below. The controller 50 controls the moving device, and thus the injection head 40 injects drips of the curing liquid to a predetermined position in the printing area. The moving device for the injection head 40 is one of the conveyors that move the printing table 24 and the injection head 40 with respect to each other.

Usable as the curing liquid may be a liquid (encompassing a viscous material) having a function of expressing bindability of particles of the powdery material 2 when being supplied to the powdery material 2. An appropriate liquid is chosen in accordance with the type of the powdery material 2 to be used. Examples of such a curing liquid include water, wax, a binder and the like. In the case where the powdery material 2 contains only the above-described main material or contains the main material and the infiltrant (sub material), the curing liquid may be, for example, a binder liquid containing a binder that exhibits the bindability and a liquid medium that dissolves or disperses the binder. In the case where the powdery material 2 contains the above-described main material and a sub material formed of a water-soluble resin, the curing liquid may be, for example, water, which dissolves the water-soluble resin. It is preferred to use water as the curing liquid because in this case, there is no possibility that the nozzle 40A of the injection head 40 is closed by the binder component.

FIG. 4 is a block diagram of the controller 50. The controller 50 includes a first controller 51, a second controller 52 and a third controller 53. There is no specific limitation on the structure of the controller 50. The controller 50 is, for example, a microcomputer. There is no specific limitation on the hardware structure of the microcomputer. The microcomputer includes, for example, an interface (I/F) 54 that receives printing data or the like from an external device such as a host computer or the like, a central processing unit (CPU) 55 that executes an instruction of a control program or programs, a ROM (read only memory) 56 that stores a program to be executed by the CPU 55, a RAM (random access memory) 57 useable as a working area in which the program is developed, and a storage 58 such as a memory or the like storing various data including the above-described program, printing data and the like. The first controller 51, the second controller 52 and the third controller 53 may each be hardware (e.g., circuit) or may be functionally realized by the CPU 55 executing the computer program or programs. The controller 50 is electrically connected with the supply portion 12b of the reservoir 10, the powder heaters 14, the motor for the powder stirrer 16, the fan 18, the table elevator 26 of the printer 20, the motor of the powder transfer conveyor 28, and the driving device and the moving device for the injection head 40, and comprehensively controls these components. The microcomputer may include a display, an input interface and the like (not shown). A user may, for example, input any of various instructions to the controller 50 via the input interface. The display may display the state of the three-dimensional printing device 1, information on the printing and the like.

The three-dimensional printed item 1B is preferably formed as follows by the three-dimensional printing device 1 in this preferred embodiment. First, the powder material 2 to be used for the printing is introduced to the reservoir 10. The powder material 2 to be used in this preferred embodiment is a powder material for printing formed of, for example, gypsum powder and PVA. Based on an instruction from the user, the controller 50 heats the powder heaters 14 to a temperature lower than the glass transition temperature of PVA. In this step, it is not necessary to change the pressure in the reservoir 10, and the pressure in the reservoir 10 may be normal pressure (1 atm). The powdery material 2 stored in the reservoir 10 is heated by the powder heaters 14 to be dried. As a result, the fluidity of the powdery material 2 stored in the reservoir 10 is improved before the powdery material 2 is supplied to the printing tank 22. How the fluidity of the powdery material 2 is improved by the heating performed by the powder heaters 14 will be described in detail below.

Next, the powdery material 2 is supplied from the reservoir 10 to the printing tank 22. In this step, first, the controller 50 controls the driving of the table elevator 26 such that the top surface of the printing table 24 is located below the top end of the printing tank 22 in the printer 20 by a predetermined size from. For example, the printing table 24 is lowered such that the top surface thereof is below the top end of the printing tank 22 by a size predefined based on a slicing thickness of cross-sectional image data (e.g., about 0.1 mm). As a result, a printing area having a predetermined height (thickness) is prepared.

Next, the reservoir 10 discharges the powdery material 2 of an amount sufficient to fill the printing area. Specifically, the controller 50 drives the powder stirrer 16 in the reservoir 10 and discharges the powdery material of a predetermined amount to the outside through the supply portion 12b. The discharged powdery material 2 falls and is supplied to the top surface 21 of the printer 20. When the supply of the powdery material 2 from the reservoir 10 is finished, the controller 50 moves the squeegee roller 28a from the roller waiting portion 28b toward the powder recovery portion 23. Specifically, the controller 50 moves the squeegee roller 28a rightward while rotating the squeegee roller 28a backward. As a result, the powdery material 2 supplied to an area between the roller waiting portion 28b and the printing tank 22 is carried to the printing tank 22 by the squeegee roller 28a. The squeegee roller 28a moves farther rightward to supply the powdery material 2 to the printing tank 22 while flattening the surface of the supplied powdery material 2. At the same time, the squeegee roller 28a carries rightward a portion of the powdery material 2 overflowing to the outside of the printing tank 22, so as to transfer such an extra portion of the powdery material 2 to the powder recovery portion 23. After moving the squeegee roller 28a to the powder recovery portion 23, the controller 50 stops rotating the squeegee roller 28a and moves the squeegee roller 28a toward the roller waiting portion 28b at the left end of the printer 20. As a result, the surface of the powdery material 2 supplied to the printer 20 is flattened uniformly, and one powdery material layer is formed in the printing area. In this state, the powdery material 2 supplied to the printer 20 has a high level of fluidity. As a result, the particles of the powdery material 2 are suppressed or prevented from being coagulated to form a lump, and thus the resultant powdery material layer is fine and homogeneous.

The controller 50 controls the moving device and the driving device for the injection head 40 to reciprocally move the injection head 40 in the front-rear direction (main scanning direction) while causing the injection head 40 to inject the curing liquid at a predetermined position in accordance with the printing data. Then, the controller 50 moves the injection head 40 rightward in the left-right direction (sub scanning direction) and again causes the injection head 40 to inject the curing direction at a predetermined position in the main scanning direction in accordance with the printing data. Such operations are repeated, so that the curing liquid is supplied in a predetermined shape to one powdery material layer. In a portion of the powdery material layer that has been supplied with the curing liquid, the curing liquid permeates into an area between the particles of the powdery material 2. For example, the water-soluble resin in the powdery material 2 is dissolved in the curing liquid and attached to the particles adjacent to each other. Then, the curing liquid is dried to solidify the water-soluble resin, so that the particles of the powdery material 2 are bound to each other. In this manner, the powder-solidified layer 1A having a shape corresponding to the printing data is formed. If there is a large gap or the like among the particles in the powdery material layer, the curing liquid is solidified in the gap and is prevented from permeating into the area between the particles. By contrast, the three-dimensional printing device 1 disclosed herein forms the powdery material layer to be fine and homogeneous, and therefore, the curing liquid permeates into the area between the particles of the powdery material layer uniformly. This allows the curing liquid to be supplied, in a shape corresponding to the printing data highly precisely, to the powdery material layer. As a result, the powder-solidified layer 1A having a high level of printing precision is provided.

When the curing liquid is supplied to the one powdery material layer, the controller 50 again controls the driving of the table elevator 26 to lower the printing table 24. As a result, a new printing area is prepared. The controller 50 controls the powder stirrer 16 in the reservoir 10 to supply the powdery material 2 from the reservoir 10 to the printer 20. The controller 50 drives the powder transfer conveyor 28 to newly form one powdery material layer. The controller 50 controls the moving device and the driving device for the injection head 40 in accordance with the printing data to supply the curing liquid in a predetermined shape to the one powdery material layer. In this manner, the controller 50 repeats preparing a powdery material layer as described above and supplying the curing liquid for each powdery material layer until the supply of the curing liquid based on the printing data is finished. As a result, the powder-solidified layers 1A are sequentially laminated integrally upward. Thus, the target three-dimensional printed item 1B is printed at a high level of printing precision.

The three-dimensional printing device 1 described above heats the powdery material 2 in the reservoir 1 to improve the fluidity of the powdery material 2. In the scientific field, an angle-of-repose measurement method is widely used as a method for evaluating the fluidity of powder. In order to evaluate the improvement in the fluidity of the powdery material 2 by the heating performed by the powder heaters 14, the powdery material 2 was stored in a highly humid environment, and the angle of repose was measured before and after the powdery material 2 was dried in the reservoir 10 of the three-dimensional printing device 1.

As the powdery material 2, gypsum powder for printing sold as being attached to a commercially available powder lamination printing device was prepared. FIG. 6 shows a scanning electron micrograph (SEM, BEC image) of the gypsum powder for printing. The gypsum powder for printing is a mixed powder material formed of gypsum powder (gypsum hemihydrate) as the main material shown white in FIG. 6 and a water-soluble resin as the sub material (the infiltrant) shown black in FIG. 6. From the results of TG-DTA measurement, the ratio of the water-soluble resin powder in the gypsum powder for printing was estimated to be about 10% by mass (the volume ratio was about 1:1 based on the SEM), and the glass transition temperature of the water-soluble resin was estimated to be about 58° C. The average particle diameter of the gypsum powder for printing was about 44 μm. The term “average particle diameter” represents 50% cumulative diameter based on a volumetric basis measured by use of MT3000EXII produced by MicrotracBEL Corp.

The angle of repose was measured as follows. The powdery material 2 was prepared as described in step (1) below and processed as described in step (2) below. Step (1): The powdery material 2 stored in the atmosphere was kept at 40° C. in a highly humid environment of 100% RH for 24 hours to put the powdery material 2 into a moisture-containing state. Specifically, the powdery material 2 was stored together with water in an incubator (EI-300B produced by AS ONE Corporation) kept at 40° C., namely, in a highly humid environment. Step (2): A portion of the powdery material 2 stored in the highly humid environment was put into the reservoir 10 of the three-dimensional printing device 1, and the powder heaters 14 were actuated to dry the powdery material 2. The heating was performed at 55° C. for 5 hours. In this step, neither the powder stirrer 16 nor the fan 18 was actuated. In this manner, the powdery material 2 was heated and dried. After each of steps (1) and (2), the weight of the powdery material 2 was measured. In addition, the powdery material 2 provided by each of (1) and (2) was dried at 105° C., and the weight of the powdery material 2 was measured. Thus, the water content of the powdery material 2 provided by each of steps (1) and (2) was determined. The results are shown in Table 1 below.

Next, the angle of repose of the powdery material 2 after each of steps (1) and (2) was measured. As described above, in step (1), the powdery material 2 was stored in the highly humid environment. In step (2), the powdery material 2 was heated and dried. The “angle of repose” is the maximum angle of an inclining surface of a deposit of powder that is kept stable without being spontaneously destroyed. In this test, the angle of repose was measured in accordance with JIS R 9301-2-2:1999 (ISO902: 1976). Specifically, the angle of repose was measured as follows. A stainless steel funnel was secured at a certain height, such that a top edge thereof had a height of 40 mm. At a temperature of 22° C., 200 g of the powdery material 2 was put into the funnel from the top edge at a predetermined pitch, and was caused to fall from the funnel onto a horizontal table. As a result, the powdery material 2 was deposited in a conical shape. The base angle of the conical shape was calculated from the diameter and the height thereof, and the base angle was set as the angle of repose. The results are shown in Table 1.

TABLE 1

| | WATER | ANGLE OF |
|---|---|---|
| | CONTENT (%) | REPOSE (°) |
| (1) HIGHLY HUMID | 2.7 | 42 |
| (2) HEATED AND DRIED | 0.5 | 35 |

As shown in Table 1, powder, when put in a highly humid environment, generally absorbs moisture in the atmosphere and is increased in the water content. The three-dimensional printing device 1 was confirmed to heat such a highly humid powdery material to decrease the water content of the highly humid powdery material, namely, dry the highly humid powdery material. The heating and drying process of the powdery material performed by the three-dimensional printing device 1 was confirmed to decrease the angle of repose.

The above-described powder for printing contains water of crystallization and thus has a water content of about 0.5% by mass after being heated, for example. The powder for printing also contains a water-soluble resin component. The water-soluble resin (the infiltrant) component easily absorbs moisture in the atmosphere, and therefore, absorbs a larger amount of moisture before being heated and dried, as compared with powder for printing containing no water-soluble resin component. The water-soluble resin component may express its properties as a result of absorbing water and thus may become viscous or bindable. For this reason, a powdery material containing a water-soluble resin is expected to have a high angle of repose. Such a powdery material having a high angle of repose and thus having a low level of fluidity may have a higher tendency of, when falling from the reservoir 10 by free fall or when being flattened by the roller, causing the adsorbing force or the viscous force thereof to act between particles or of forming lumps. As a result, the powdery material supplied to the printing area may contain lumps, which may be exposed to a surface of the resultant three-dimensional printed item 1B. This may decrease the printing precision.

After the powdery material is heated and dried, the adsorbing force of the powdery material provided by water contained therein, and viscosity of the powdery material provided by the water-soluble resin, are suppressed or prevented. As a result, the angle of repose of the powdery material is decreased. According to the classification of the Carr, which is an indication in design of a powder transportation system or the like, the fluidity of powder is evaluated to be “normal” when the repose of angle is higher than 40 degrees and 45 degrees or lower, is evaluated to be “relatively good” when the repose of angle is higher than 35 degrees and 40 degrees or lower, and is evaluated to be “good” when the repose of angle is higher than 30 degrees and 35 degrees or lower. It has been discovered that in the case where the powdery material 2 is heated and dried by the three-dimensional printing device 1, the fluidity of the powdery material 2 at the time of fall may be improved, for example, from “normal” to “good”. In the three-dimensional printing device 1, the powdery material layers need to have a higher fluidity than that during powder transportation. A powdery material having a low angle of repose and a high level of fluidity, when being supplied from the reservoir 10 to the printer 20 by free fall, is supplied with good fluidity to the printing tank 22 and thus is preferred. It has been confirmed by visual checking that in the case where the powdery material is used after being heated and dried, the resultant three-dimensional printed item 1B has an improved level of surface smoothness and a higher visual and tactile quality with no lump of the powdery material being exposed to the surface thereof, as compared with the case where the powdery material is used without being heated or dried. Even in the case where relatively rugged powder for printing as shown in FIG. 6 is used, the three-dimensional printing device 1 disclosed herein may increase the angle of repose of the powder. As can be seen, the three-dimensional printing device 1 performs three-dimensional printing with a high level of printing precision. Although specific data is not shown, it has been confirmed that even alumina powder for printing containing crushed alumina powder that is more rugged than the above-described powder for printing shown in FIG. 6 may be improved in the angle of repose by about 5 degrees or higher when being heated and dried by the three-dimensional printing device 1.

In the three-dimensional printing device 1 described above, the first controller 51 may control the powder heaters 14 such that the powder heaters 14 heat the powdery material 2 to a predetermined temperature of about 25° C. or higher and about 105° C. or lower, for example. This allows the powdery material 2 to be adjusted into an appropriate dry state in the reservoir 10, and thus to have the fluidity thereof improved in a preferred manner. The temperature to which the powdery material 2 is to be heated by the first controller 51 may be appropriately determined in accordance with the type of the powdery material 2. In the case where, for example, the powdery material 2 contains a water-soluble resin, the temperature may be set to a level lower than the glass transition temperature of the water-soluble resin in order to prevent the water-soluble resin from being softened, melted or denatured. Although depending on the type of the powdery material 2, the temperature to which the powdery material 2 is to be heated may be, for example, about 25° C. or higher, preferably about 35° C. or higher, for example, about 40° C. or higher, and for example, about 80° C. or lower, preferably about 70° C. or lower, for example, about 60° C. or lower, or about 55° C. or lower. With such an arrangement, the powdery material 2 is improved in the fluidity and the ease of being impregnated with the curing liquid without being, for example, denatured or deteriorated before being supplied to the printer 20. This allows the three-dimensional printed item 1B to be printed highly precisely to be fine and homogeneous. A portion of the powdery material 2 that has not been used to form the three-dimensional printed item 1B is reused. The above-described heating performed at a low temperature is preferred because the powdery material 2 to be reused is not excessively damaged in repetition.

The second controller 52 may control the powder heaters 14 such that the powder heaters 14 heat the powdery material 2 while the three-dimensional printing device 1 is not performing printing. For example, the second controller 52 may configured or programmed to actuate the powder heaters 14 at the time designated by the user, for example, during the nighttime. In this manner, the time when the three-dimensional printing device 1 is not performing printing, for example, the nighttime, may be used to dry the powdery material 2 sufficiently at a low temperature. Alternatively, in the case where, for example, the nighttime is used to form the three-dimensional printed item 1B, the second controller 52 may be configured or programmed such that the powder heaters 14 perform heating before substantial printing. This allows the fluidity of the powdery material 2 to be improved by use of the time when the three-dimensional printing device 1 is not performing printing. Herein, the term “substantial printing” refers to a process from supply of the powdery material 2 to the printing tank 22 (preparation of the powdery material layer) to the finish of the printing of the three-dimensional printed item 1B. The “time when the three-dimensional printing device 1 is not performing printing” refers to the time when the process from supply of the powdery material 2 to the printing tank 22 (preparation of the powdery material layer) to the finish of the printing of the three-dimensional printed item 1B is not performed.

The third controller 53 controls the powder heaters 14 such that the powder heaters 14 heat the powdery material 2 while the powdery material 2 is being supplied from the reservoir 10 to the printing table 24 in the three-dimensional printing device 1. For example, the third controller 53 may be configured or programmed to actuate the powder heaters 14 before the powdery material 2 starts to be supplied for printing. In this manner, even in the case where the powdery material 2 dried during the nighttime or the like is cooled, the powdery material 2 may be warmed to a temperature suitable for the permeation of the curing liquid. This improves the permeability of the curing liquid into the powdery material layer in a preferred manner.

In the above-described preferred embodiment, the powder stirrer 16 provided in the reservoir 10 is not driven while the powder heaters 14 are heating the powdery material 2.

Alternatively, the powder stirrer 16 may be controlled to stir the powdery material 2 while the powdery material 2 is being heated by the powder heaters 14. This promotes the heating and drying of the powdery material 2 by the powder heaters 14. It is preferred that the powder stirrer 16 stirs the powdery material 2 as described above also because even in the case where the powdery material 2 has already absorbed moisture to form lumps while, for example, being stored by the user, such lumps may be broken to become powdery by the powdery material 2 being stirred by the powder stirrer 16 at the same time as being heated in the reservoir 10. The powder stirrer 16 may be controlled to stir the powdery material 2 during the printing. This suppresses or prevents the powdery material 2 from clogging when the powdery material 2 is supplied from the reservoir 10 to the printer 20 and improves the ease of supply, and thus is preferred.

In the above-described preferred embodiment, the fan 18 provided in the reservoir 10 is not driven while the powder heaters 14 are heating the powdery material 2. Alternatively, the fan 18 may be controlled to exchange gas inside the reservoir tank 12 with gas outside the reservoir tank 12 while the powdery material 2 is being heated by the powder heaters 14. This improves the effect of drying the powdery material 2 by the powder heaters 14. There is a possibility that while the fan 18 is operating, microscopic particles of the powdery material 2 may be absorbed upward and discharged outside the reservoir tank 12. Especially when the powder heaters 14 are driven, the powdery material 2 may be easily blown up by the powder heaters 14 and discharged outside by the fan 18. If the powdery material 2 is discharged outside the reservoir tank 12, the environment in which the three-dimensional printing device 1 is installed is contaminated with the powdery material 2. However, in this preferred embodiment, the filter 17 provided between the reservoir tank 12 and the fan 18 prevents the powdery material 2 from being discharged outside.

In the three-dimensional printing device 1 disclosed herein, the reservoir tank 12 for the powdery material 2 is located above the printer 20. Therefore, a dead space above the printer 20 is used to locate the reservoir tank 12. This decreases the size of the area required to install the three-dimensional printing device 1 and makes the three-dimensional printing device 1 more compact. In this preferred embodiment, falling due to gravity is used to supply the powdery material 2 from the reservoir tank 12 to the printer 20. According to preferred embodiments of the present invention, the fluidity of the powdery material 2 is improved. Therefore, the powdery material 2 is supplied in a preferred manner from the slit-shaped supply portion 12b to the printer 20, without clogging the slit-shaped supply portion 12b. The powder heaters 14 provided outside the reservoir tank 12 dry the powdery material 2. This allows the powdery material 2 to be dried with no need of a large-scale device such as, for example, a vacuum drier or the like.

In the above-described preferred embodiment, the reservoir tank 12 is provided with the slit-shaped supply portion 12b, and the powdery material 2 is supplied to the printer 20 by falling due to gravity. The reservoir 10 is not limited to having such a structure. The reservoir 10 may include a powder transfer conveyor such as, for example, a rotary valve or the like as the supply portion 12b. This allows the powdery material 2 of a desired amount to be supplied to the printer 20 at a desired timing to print each layer.

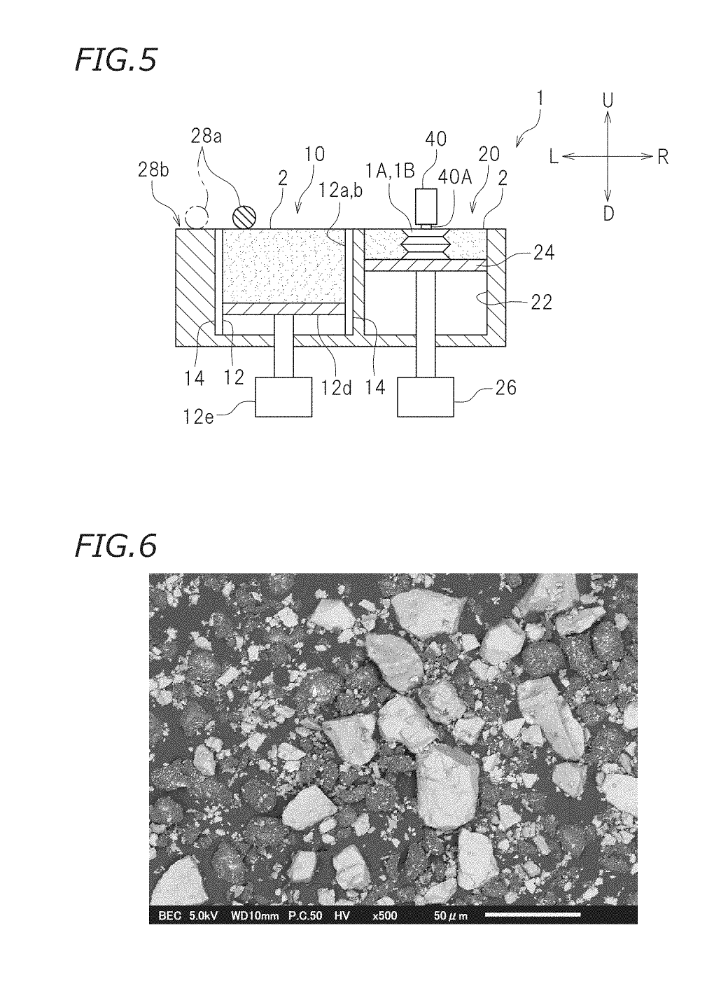

In the above-described preferred embodiment, the reservoir 10 preferably includes the supply portion 12b at the bottom end thereof, and is located above the printing table 24. The three-dimensional printing device 1 according to the present invention is not limited to having such a structure. For example, as shown in FIG. 5, the reservoir 10 may be provided to the side of the printer 20 including the printing table 24. In this case, the reservoir 10 may have substantially the same structure as that of the printer 20. This will be described more specifically. The reservoir tank 12 storing the powdery material 2 is recessed from the top surface 21 of the printer 20, and an opening commonly acting as the opening 12a and the supply portion 12b is provided in a top portion of the reservoir tank 12. The powder heaters 14 are provided, for example, around a side wall of the reservoir tank 12. A supply table 12d extruding and supplying the powdery material 2 is provided inside the reservoir tank 12. The supply table 12d has a shape corresponding to a shape of a bottom surface of the reservoir tank 12, and a bottom surface of the supply table 12d is supported by a table elevator 12e. The supply table 12d is driven by the table elevator 12e to move upward and downward in the reservoir tank 12. The supply table 12d is raised, so that the powdery material 2 stored in the reservoir tank 12 is extruded above the top surface 21. The squeegee roller 28a is moved while rotating, so that the powdery material 2 is transferred and supplied to the printer 20. Although not shown specifically, the powder stirrer 16 stirring the powdery material 2 may be provided on a top surface of the supply table 12d. The reservoir 10 having such a structure heats the powdery material 2 stored in the reservoir tank 12 and thus improves the fluidity of the powdery material 2.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the present disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing device, comprising:
a reservoir that stores a powdery material;
a powder heater provided in the reservoir to heat the powdery material;
a printing table that allows the powdery material to be put thereon;
an injection head that injects a curing liquid binding the powdery material; and
a conveyor that moves the printing table and the injection head with respect to each other.

2. The three-dimensional printing device according to claim 1, further comprising a controller that controls the powder heater; wherein
the controller includes a controller that controls the powder heater such that the powder heater heats the powdery material to a temperature of about 25° C. or higher and about 105° C. or lower.

3. The three-dimensional printing device according to claim 1, further comprising a controller that controls the powder heater; wherein
the controller includes a controller that controls the powder heater such that the powder heater heats the powdery material while the three-dimensional printing device is not performing printing.

4. The three-dimensional printing device according to claim 1, further comprising a controller that controls the powder heater; wherein
the controller includes a controller that controls the powder heater such that the powder heater heats the powdery material while the powdery material is being supplied from the reservoir to the printing table.

5. The three-dimensional printing device according to claim 1, further comprising a powder stirrer provided in the reservoir to stir the powdery material.

6. The three-dimensional printing device according to claim 1, further comprising a fan provided in the reservoir to discharge gas in the reservoir to outside of the reservoir.

7. The three-dimensional printing device according to claim 6, further comprising a filter provided between an inner space of the reservoir and the fan to prevent the powdery material stored in the reservoir from being discharged to the outside of the reservoir.

8. The three-dimensional printing device according to claim 1, wherein the powdery material contains powder including at least one of an inorganic material and a metal material and also contains an infiltrant that promotes permeation of the curing liquid to cure the powdery material.

9. The three-dimensional printing device according to claim 1, wherein the reservoir is provided with a supply opening, is located above the printing table, and allows the powdery material to fall through the supply opening.
